(19) United States
(12) Patent Application Publication
(10) Pub. No.: US 2025/0263965 A1
(43) Pub. Date: Aug. 21, 2025

(54) ELECTRIC TAILGATE STRUT

(71) Applicant: Changzhou Weien Technology Development Co., Ltd, Changzhou (CN)

(72) Inventors: Zhiwen TAO, Changzhou (CN); Xiaogang LI, Changzhou (CN)

(73) Assignee: Changzhou Weien Technology Development Co., Ltd, Changzhou (CN)

(21) Appl. No.: 19/019,566

(22) Filed: Jan. 14, 2025

(30) Foreign Application Priority Data
Feb. 20, 2024 (CN) 202420308406.5

(51) Int. Cl. E05F 15/622; E05F 3/02

(52) U.S. Cl. CPC E05F 15/622; E05F 3/02; E05Y 2201/434; E05Y 2201/478; E05Y 2800/236; E05Y 2900/546

(57) ABSTRACT

An electric tailgate strut includes telescopic rod, gas spring, driving unit and tailgate connection assembly. Telescopic rod comprises outer tube and inner tube, wherein the outer tube can move along the axial direction of inner tube. Gas spring is arranged inside telescopic rod and includes thread tube with thread on inner wall, piston and piston rod. Driving unit is fixedly arranged in the outer tube and serves to drive piston rod in the rotation so that piston rod drives outer tube to move along axial direction of inner tube. Tailgate connection assembly is located at both ends of telescopic rod and is used for connection between telescopic rod and tailgate. Piston rod is driven to rotate by motor, so that outer tube can move along axial direction of inner tube to achieve rise or fall of strut. Thread tube itself, piston rod and piston form a gas spring.

### CROSS REFERENCE TO THE RELATED APPLICATIONS

This application is based upon and claims priority to Chinese Patent Application No. 202420308406.5, filed on Feb. 20, 2024, the entire contents of which are incorporated herein by reference.

### TECHNICAL FIELD

The present invention relates to technical field of tailgate strut, especially to electric tailgate strut.

### BACKGROUND

The tailgate opening and closing system for automobiles is generally divided into two types, namely electric system as well as manual system. The electric tailgate opening and closing system for automobiles can be further divided into two configuration schemes, one is to install two electric struts (PR, a product that is extended and compressed by motor-driven screw actuator) on left and right sides of tailgate, which is PR+PR, the other is to install an electric strut (PR) and a pneumatic balance strut (FEBI, a product with the appearance of an electric strut and a traditional gas spring inside) on left and right sides of tailgate, which is PR+FEBI.

Since traditional electric struts generally do not possess the damp construction when using PR+PR configuration scheme, tailgate is prone to shake during rising or falling process of electric strut, affecting the experience of user negatively. When using PR+FEBI configuration scheme, the smoothness of tailgate when opening or closing is greatly improved. However, for heavy vehicles with large tailgate mass such as off-road vehicles, the power may not be sufficient when a single electric strut is used.

### SUMMARY

To solve problems existing in prior art, the present invention proposes the electric tailgate strut.

To achieve above-mentioned purpose, the present invention adopts the following technical solutions:

The electric tailgate strut, including
telescopic rod, which includes outer tube and inner tube, wherein the outer tube can move along the axial direction of inner tube,
gas spring, which is arranged inside the telescopic rod and includes thread tube with thread on inner wall, piston and piston rod, wherein distance between thread tube as well as inner tube remains constant, wherein piston is located at the free end of piston rod and in the rotary seat with inner wall of thread tube, wherein seal guide assembly is provided between piston rod as well as thread tube,
driving unit, which is fixedly arranged in outer tube and serves to drive piston rod in the rotation so that piston rod drives outer tube to move along axial direction of inner tube, and
tailgate connection assembly, which is located at both ends of telescopic rod and is used for connection between telescopic rod and tailgate.

Preferably, the inner wall of thread tube is provided with thread projection, wherein piston is provided with thread groove which matches the thread projection, and wherein there is no self-locking between the piston and the thread tube.

Preferably, inner wall of outer tube is provided with first grooves evenly distributed along its axis, wherein
outer wall of inner tube is provided with the first convex strips evenly distributed along its axis, wherein inner wall of inner tube is provided with second grooves evenly distributed along its axis, wherein first convex strip matches first groove, wherein
lower end of inner tube is provided with inner tube plug, and wherein side wall of inner tube plug is provided with second convex strip, which is adapted to second groove.

Preferably, the back plug of thread tube is permanently installed at the end of thread tube, wherein back plug of thread tube is permanently connected to inner tube plug.

Preferably, one end of inner tube plug is provided with the connecting rod for back plug, which is connected to the back plug of thread tube, and wherein the other end of inner tube plug of the lifting rod is provided with tailgate connection assembly.

Preferably, outer tube plug is firmly installed at the end of outer tube, wherein power lead hole is preset on end or side of outer tube plug, and wherein third convex strip is arranged on side wall of outer tube plug, which matches first groove.

Preferably, the driving unit includes motor, gear box and controller, wherein output end of motor drives thread tube for rotation through gear box.

Preferably, the seal guide assembly includes spacer sleeve, oil seal and rear upper sleeve, wherein oil seal is located between spacer sleeve and rear upper sleeve, and wherein the rear upper sleeve is fixedly connected to the end of thread tube.

Preferably, tailgate connection assembly is ball socket or ball head, wherein connection assembly at least at one end of telescopic rod can rotate in the circumferential direction.

Preferably, it further includes protective cover, which includes an outer tube protective cover arranged at the end of the outer tube and an inner tube protective cover arranged at the end of the inner tube.

The beneficial effects of the present invention are as follows:

1. In the present electric tailgate strut, piston rod is driven to rotate by motor, so that outer tube can move along axial direction of inner tube to achieve rise or fall of strut. Thread tube itself, piston rod and piston form a gas spring, which effectively improves smoothness of tailgate when opening or closing. On other hand, when electric tailgate strut is extended, gas spring has a certain output force, which can reduce load of motor and increase thrust under the same conditions.

2. In the present electric tailgate strut, thread tube, piston rod as well as piston form a non-lockable gas spring. By controlling the rotation of motors, the rotation of thread tube can be limited, and gas spring can be automatically locked, which improves stability of electric tailgate strut of the automobiles.

3. Protective covers are provided at the ends of outer tube and inner tube, which can play a role in waterproofing and dustproofing.

### BRIEF DESCRIPTION OF THE DRAWINGS

FIG. 1 shows a schematic diagram of the three-dimensional structure related to the electric tailgate strut of the present invention.

FIG. 2 shows a schematic diagram of the front view related to the electric tailgate strut of the present invention.

FIG. 3 shows a schematic cross-sectional view related to A-A section of FIG. 2 of electric tailgate strut of the present invention.

FIG. 4 shows a schematic diagram of the three-dimensional structure related to outer tube of the electric tailgate strut of the present invention.

FIG. 5 shows a schematic diagram of the three-dimensional structure related to inner tube of the electric tailgate strut of the present invention.

FIG. 6 shows a schematic diagram of the front view related to thread tube of the electric tailgate strut of the present invention.

FIG. 7 shows a schematic cross-sectional view related to B-B section of FIG. 6 of electric tailgate strut of the present invention.

FIG. 8 shows a schematic diagram of the three-dimensional structure related to the piston of the electric tailgate strut of the present invention.

FIG. 9 shows a schematic diagram of the three-dimensional structure related to the inner tube plug of the electric tailgate strut of the present invention.

FIG. 10 shows a schematic structural diagram related to the inner tube plug of the electric tailgate strut in another embodiment of the present invention.

FIG. 11 shows a schematic diagram of the three-dimensional structure related to the outer tube plug of the electric tailgate strut of the present invention.

Among them: 1. Outer tube; 2. Inner tube; 3. Thread tube; 4. Motor; 5. Gear box; 6. Coupling; 7. Piston rod; 8. Piston; 9. Shock-absorbing pad; 10. Rear upper sleeve; 11. Oil seal; 12. Spacer sleeve; 13. Back plug of thread tube; 14. Inner tube plug; 15. First ball socket; 16. Outer tube plug; 17. Second ball socket; 18. Outer tube protective cover; 19. Inner tube protective cover; 101. First groove; 201. First convex strip; 202. Second groove; 301. Thread groove; 801. Thread projection; 141. Second convex strip; 161. Third convex strip.

### DETAILED DESCRIPTION OF THE EMBODIMENTS

The technical solution in embodiments of present invention will be clearly and completely described below in combination with the attached drawings in embodiment of present invention. Obviously, the embodiments described are only part of the embodiments of the present invention, not all embodiments.

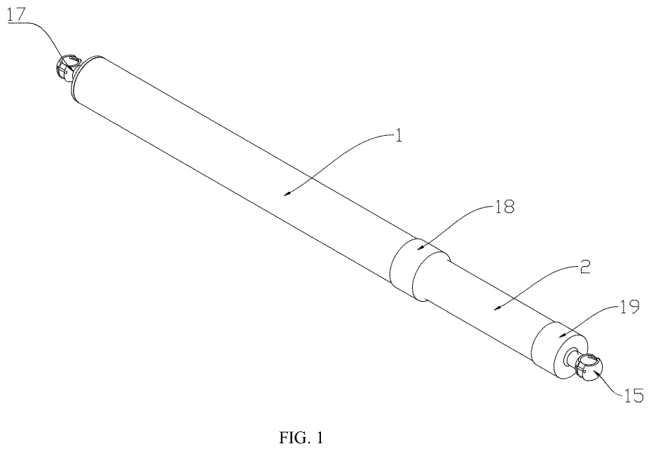

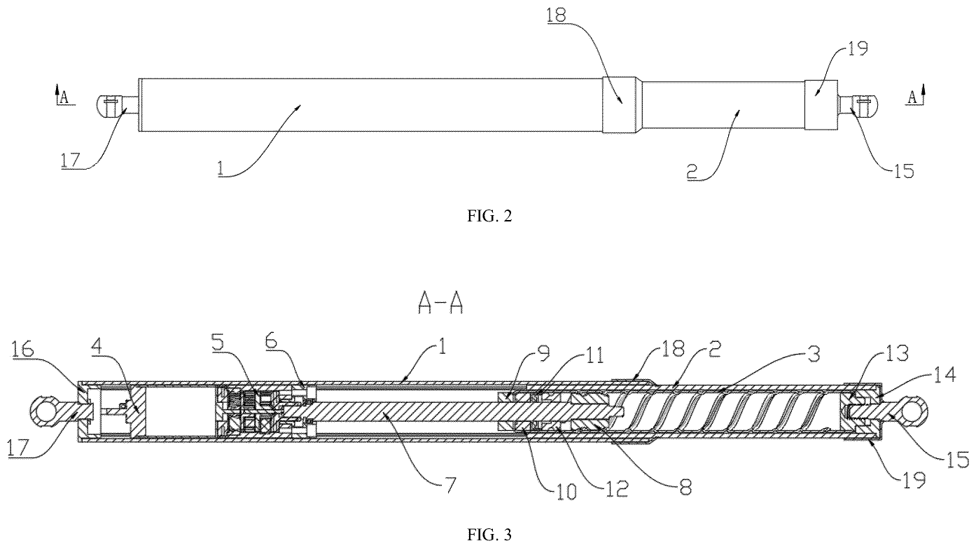

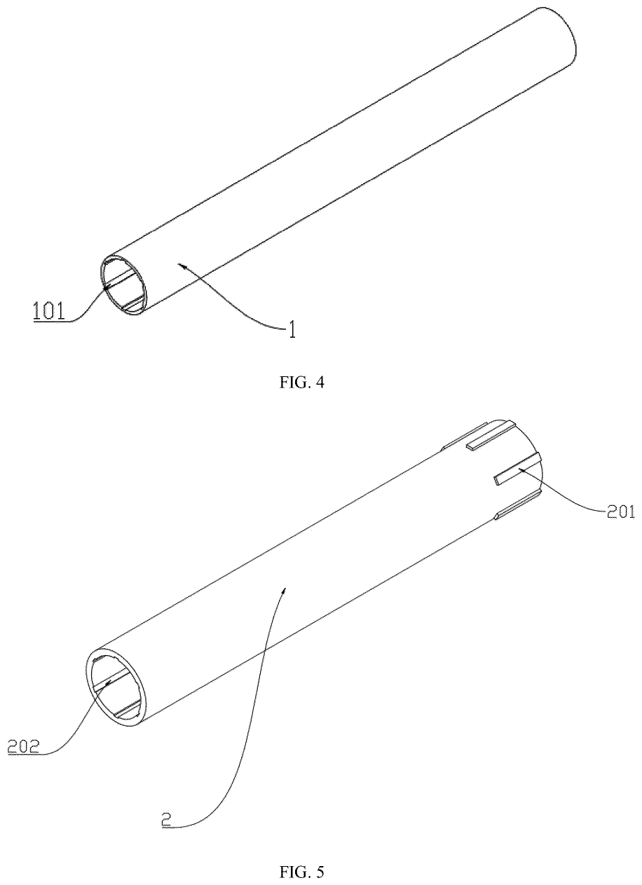

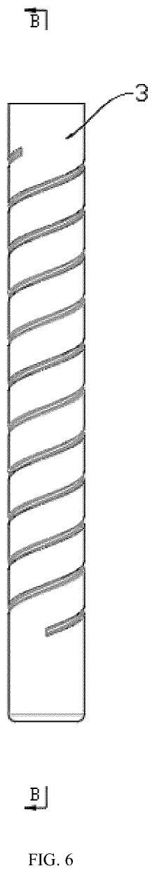

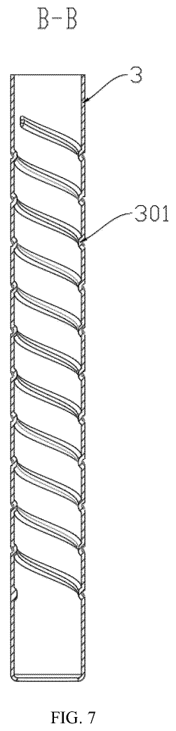

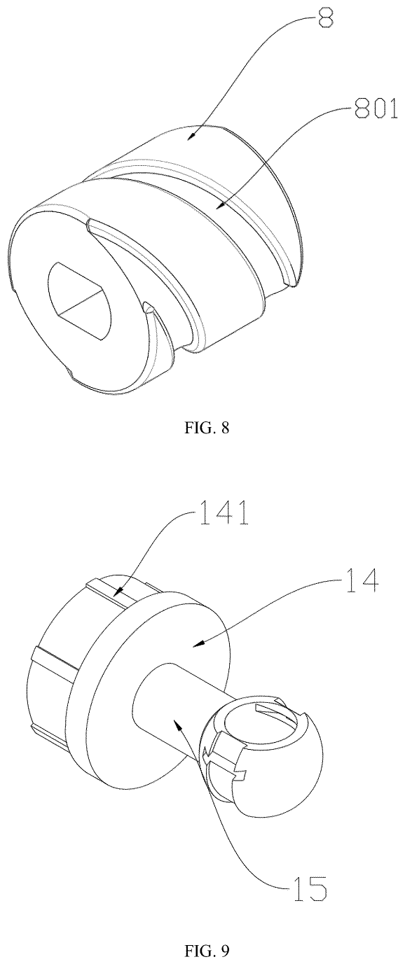

Referring to FIGS. 1 to 11, the electric tailgate strut includes:
telescopic rod, which includes outer tube 1 as well as inner tube 2, wherein outer tube 1 can move along the axial direction of inner tube 2,
gas spring, which is arranged inside telescopic rod and includes thread tube 3 with thread on inner wall, piston 8 and piston rod 7, wherein distance between thread tube 3 and inner tube 2 remains constant, wherein piston 8 is located at free end of piston rod 7 and in rotary seat with inner wall of thread tube 3, wherein seal guide assembly is provided between piston rod 7 and thread tube 3,
driving unit, which is fixedly arranged in outer tube 1 and serves to drive piston rod 7 in the rotation so that piston rod 7 drives outer tube 1 to move along axial direction of inner tube 2, and
tailgate connection assembly, which is located at both ends of telescopic rod and is used for connection between telescopic rod and tailgate.

The inner wall of thread tube 3 is provided with thread projection 801, wherein piston 8 is provided with thread groove 301 which matches thread projection 801, and wherein there is no self-locking between piston 8 and thread tube 3.

Inner wall of outer tube 1 is provided with first grooves 101 evenly distributed along its axis, wherein
outer wall of inner tube 2 is provided with first convex strips 201 evenly distributed along its axis, wherein inner wall of inner tube 2 is provided with second grooves 202 evenly distributed along its axis, wherein first convex strip 201 matches first groove 101, wherein
lower end of inner tube 2 is provided with inner tube plug 14, and wherein the side wall of inner tube plug 14 is provided with second convex strip 141, which is adapted to second groove 202.

Back plug of thread tube 13 is permanently installed at the end of thread tube 3, wherein back plug of thread tube 13 is permanently connected to inner tube plug 14.

One end of inner tube plug 14 is provided with the connecting rod for back plug which is connected to back plug of thread tube 13, wherein the other end of inner tube plug 14 of lifting rod is provided with tailgate connection assembly.

Outer tube plug 16 is firmly installed at the end of outer tube 1, wherein power lead hole is preset on end or side of outer tube plug 16, and wherein third convex strip 161 is arranged on the side wall of outer tube plug 16, which matches first groove 101.

Driving unit includes motor 4, gear box 5 and controller. Output end of motor 4 drives thread tube 3 to rotate through the gear box 5. Gear box 5 is planetary reduction gear box, and the controller is Hall encoder or other signal feedback unit. Output end of gear box 5 can be connected to end of piston rod 7 through coupling 6. The end of piston rod 7 can also be installed with double-car back plug, which is connected to output shaft of gear box 5 through double-car back plug and pin shaft.

The area on piston rod 7 between coupling 6 and thread tube 3 is covered with the shock-absorbing pad 9.

Seal guide assembly includes spacer sleeve 12, oil seal 11 as well as rear upper sleeve 10, wherein oil seal 11 is located between spacer sleeve 12 and rear upper sleeve 10, and wherein the rear upper sleeve 10 is fixedly connected to end of thread tube 3.

Tailgate connection assembly is ball socket or ball head, wherein connection assembly at least at one end of telescopic rod can rotate in the circumferential direction.

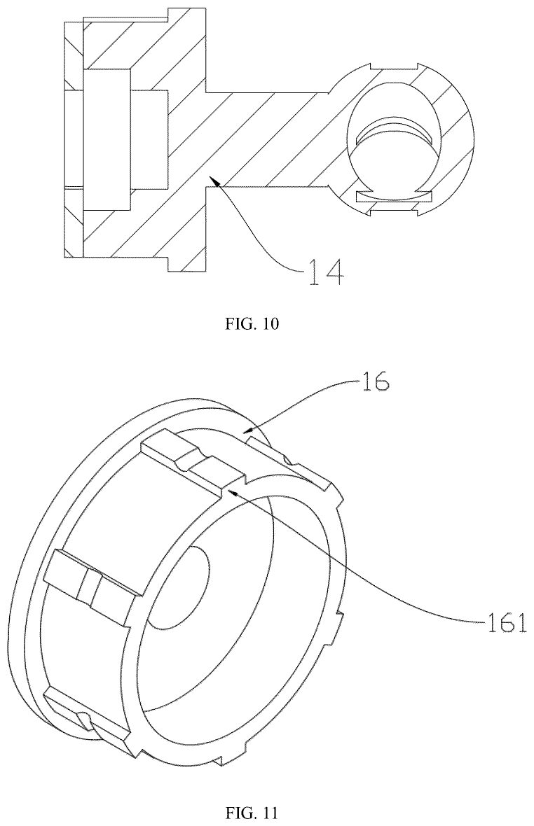

When the tailgate connection assembly is a ball socket, it includes second ball socket 17 connected to outer tube plug 16 and first ball socket 15 connected to inner tube plug 14, and ball socket at least at one end of telescopic rod can rotate in the circumferential direction. As shown in FIG. 10, inner tube plug 14 is integrally formed with first ball socket 15 in the present schematic diagram, and first ball socket 15 cannot rotate. At this time, second ball socket 17 must be able to rotate around axis of the outer tube plug 16 to facilitate smooth installation of the tailgate strut.

It further includes the protective cover, which includes outer tube protective cover 18 arranged at the end of outer tube 1 and inner tube protective cover 19 arranged at the end of inner tube 2. Outer tube protective cover 18 is provided at both ends of the outer tube 1.

In the present electric tailgate strut, piston rod 7 is driven to rotate by motor 4, so that the outer tube 1 can move along axial direction of inner tube 2 to achieve rise or fall of strut. The thread tube 3 itself, piston rod 7 and piston 8 form a gas spring, which effectively improves smoothness of the tailgate when opening or closing. On the other hand, when electric tailgate strut is extended, the gas spring has a certain output force, which can reduce the load of motor 4 and increase the thrust under the same conditions.

In the present electric tailgate strut, thread tube 3, piston rod 7 and piston 8 form a non-lockable gas spring. By controlling the rotation of motor 4, the rotation of thread tube 3 can be limited, and the gas spring can be automatically locked, which improves stability of electric tailgate strut of the automobiles.

Protective covers are provided at the ends of outer tube 1 and inner tube 2, which can play a role in waterproofing and dustproofing.

The above content is only a preferred embodiment of the present invention. For ordinary technicians in the art, the changes are obtained based on the exemplary embodiment and applying scope according to the idea of the present invention, the content of the specification should not be understood as a limitation of the present invention. Any modifications, improvements, equivalent replacements and the like, made within the spirit as well as principle of the present invention, shall all be included in the protection scope of the present invention.

What is claimed is:

1. An electric tailgate strut, comprising:
a telescopic rod, wherein the telescopic rod comprises an outer tube and an inner tube, and the outer tube is configured to move along an axial direction of the inner tube,
a gas spring, wherein the gas spring is arranged inside the telescopic rod and comprises a thread tube with a thread on an inner wall, a piston and a piston rod; a distance between the thread tube and the inner tube remains constant; the piston is located at a free end of the piston rod and in a rotary seat with the inner wall of the thread tube; and a seal guide assembly is provided between the piston rod and the thread tube,
a driving unit, wherein the driving unit is fixedly arranged in the outer tube and serves to drive the piston rod in rotation so that the piston rod drives the outer tube to move along the axial direction of the inner tube, and
a tailgate connection assembly, wherein the tailgate connection assembly is located at both ends of the telescopic rod and is used for a connection between the telescopic rod and a tailgate.

2. The electric tailgate strut according to claim 1, wherein the inner wall of the thread tube is provided with a thread projection, the piston is provided with a thread groove matching with the thread projection, and there is no self-locking between the piston and the thread tube.

3. The electric tailgate strut according to claim 2, wherein an inner wall of the outer tube is provided with first grooves evenly distributed along an axis of the outer tube;
an outer wall of the inner tube is provided with the first convex strips evenly distributed along an axis of the inner tube, an inner wall of the inner tube is provided with second grooves evenly distributed along the axis of the inner tube, and the first convex strips respectively match the first grooves, wherein
a lower end of the inner tube is provided with an inner tube plug, and a side wall of the inner tube plug is provided with a second convex strip adapted to each of the second grooves.

4. The electric tailgate strut according to claim 3, wherein a back plug of the thread tube is permanently installed at an end of the thread tube, and the back plug of the thread tube is permanently connected to the inner tube plug.

5. The electric tailgate strut according to claim 4, wherein a first end of the inner tube plug is provided with a connecting rod for the back plug, the connecting rod is connected to the back plug of the thread tube, and a second end of the inner tube plug of a lifting rod is provided with the tailgate connection assembly.

6. The electric tailgate strut according to claim 5, wherein an outer tube plug is firmly installed at an end of the outer tube, a power lead hole is preset on an end or a side of the outer tube plug, and a third convex strip is arranged on a side wall of the outer tube plug and matches each of the first grooves.

7. The electric tailgate strut according to claim 1, wherein the driving unit comprises a motor, a gear box and a controller, wherein an output end of the motor drives the thread tube for rotation through the gear box.

8. The electric tailgate strut according to claim 7, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.

9. The electric tailgate strut according to claim 8, wherein the tailgate connection assembly is a ball socket or a ball head, and the tailgate connection assembly at least at one end of the telescopic rod is configured to rotate in a circumferential direction.

10. The electric tailgate strut according to claim 9, further comprising a protective cover, wherein the protective cover comprises an outer tube protective cover arranged at an end of the outer tube and an inner tube protective cover arranged at an end of the inner tube.

11. The electric tailgate strut according to claim 2, wherein the driving unit comprises a motor, a gear box and a controller, wherein an output end of the motor drives the thread tube for rotation through the gear box.

12. The electric tailgate strut according to claim 3, wherein the driving unit comprises a motor, a gear box and a controller, wherein an output end of the motor drives the thread tube for rotation through the gear box.

13. The electric tailgate strut according to claim 4, wherein the driving unit comprises a motor, a gear box and a controller, wherein an output end of the motor drives the thread tube for rotation through the gear box.

14. The electric tailgate strut according to claim 5, wherein the driving unit comprises a motor, a gear box and a controller, wherein an output end of the motor drives the thread tube for rotation through the gear box.

15. The electric tailgate strut according to claim 6, wherein the driving unit comprises a motor, a gear box and a controller, wherein an output end of the motor drives the thread tube for rotation through the gear box.

16. The electric tailgate strut according to claim 11, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.

17. The electric tailgate strut according to claim 12, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.

18. The electric tailgate strut according to claim 13, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.

19. The electric tailgate strut according to claim 14, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.

20. The electric tailgate strut according to claim 15, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.
